(19) United States
(12) Patent Application Publication
(10) Pub. No.: US 2024/0336813 A1
(43) Pub. Date: Oct. 10, 2024

(54) KIT FOR IMPROVED OXYGEN BARRIER COATING AND PRODUCT COMPRISING AN IMPROVED OXYGEN BARRIER COATING

(71) Applicants: Siegwerk Druckfarben AG & Co. KGaA, Siegburg (DE); Henkel IP & Holding GmbH, Düsseldorf (DE)

(72) Inventors: Lothar SCHÄFFELER, Clive, IA (US); Steven BROKMAN, Huxley, IA (US); Michael SCHMIDT, Köln (DE); Andreas JARZEBSKI, Bonn (DE); Martin HOFFMANN, Brühl (DE); Guido KOLLBACH, Bridgewater, NJ (US); Mathew AHEARN, Bridgewater, NJ (US)

(73) Assignees: Siegwerk Druckfarben AG & Co. KGaA, Siegburg (DE); Henkel IP & Holding GmbH, Düsseldorf (DE)

(21) Appl. No.: 18/579,123

(22) PCT Filed: Jul. 4, 2022
(86) PCT No.: PCT/EP2022/068401

§ 371 Date: Jan. 12, 2024

Related U.S. Application Data
(60) Provisional application No. 63/222,042, filed on Jul. 15, 2021.

(51) Int. Cl. C09J 7/29; C09D 11/102; C09D 11/106; C09D 11/107; C09D 11/14; C09J 7/35

(52) U.S. Cl. CPC C09J 7/29; C09D 11/102; C09D 11/106; C09D 11/107; C09D 11/14; C09J 7/35; C09J 2301/162; C09J 2301/304; C09J 2401/006; C09J 2423/00; C09J 2427/006; C09J 2433/006; C09J 2475/006

(57) ABSTRACT

The present invention is related to a kit (K), comprising a composition for preparing an oxygen barrier coating (1c) comprising a polymer having reactive hydroxyl groups, and a composition for preparing a layer selected from the group consisting of an ink layer (1b), an overprint varnish layer (1h) and an adhesive layer (1i), wherein composition b) comprises a component that is capable of crosslinking with the polymer of composition a) when compositions a) and b) are applied one after another onto an uncoated or coated substrate (1a).

The present invention is related to a kit for making an improved oxygen barrier coating and a product comprising said improved oxygen barrier coating.

Articles made of plastic (i.e. synthetic polymers such as polyethylene (PE), polypropylene (PP) or polyethylene terephthalate (PET)) are extremely efficient for the purposes of flexible packaging. However, this advantage has led to an extreme use of plastic materials, and without efficient recycling the environmental pollution that can already be observed (e.g. pollution of the oceans) will increase.

Flexible packaging materials that are intended for food applications (or pharmaceutical applications or other materials which need protection) furthermore comprise functional coating layers in addition to layers made from the above plastic materials. Plastic materials do not satisfactorily prevent permeation of oxygen and moisture. As a consequence, food provided within said flexible packaging may suffer from detrimental effects such as oxidation or hydration/dehydration. To address this problem, oxygen barrier coating layers have been provided in flexible packaging materials. Conventionally, coatings consisting of metals and chlorinated polymers, such as poly (vinyl chloride) (PVC) and poly (vinylidene chloride) (PVDC), have been used for this purpose. Aluminum oxide with an oxygen transmission rate (OTR) of approximately 1 mL/m² day has been most commonly used these days (Thuy et al., Green Chem., 2021, 23, 2658).

However, flexible packaging materials comprising such an oxygen barrier coating layer often give rise to health and environmental issues, due to the characteristics of the used materials (presence of metals, chlorinated polymers). If one wants to recycle flexible packaging materials comprising such an oxygen barrier coating layer, one would have first to delaminate said oxygen barrier coating layer. However, this is not an easy process and furthermore expensive. Accordingly, today still many food packaging wastes are disposed of through landfills or incineration. Upon burning, PVDC and PVC release hazardous gases. Moreover, incineration of plastic materials is detrimental with respect to the amount of CO₂ released therewith and its contribution to global warming.

In some regions (e.g. the EU) regulations have been implemented requiring a certain recycling rate to be obtained until a certain point in time. Furthermore and independent from regulations, all major brand owners made commitments to increase the amount of recycled material in their products.

In order to address the problems that are associated with oxygen barrier coating layers consisting of metals and chlorinated polymers, oxygen barrier coating layers have been suggested that are made from polyvinyl alcohol (PVOH) (e.g. U.S. Pat. No. 5,508,113 A).

While, such layers address the environmental and health problems mentioned above, they are typically applied as an aqueous solution and do not dry sufficiently fast when being applied onto a conventional substrate such as a film made from polyethylene (PE) or polypropylene (PP). Accordingly, subsequent layers such as ink layers cannot be applied onto said oxygen barrier layer with the printing speed required for commercial applications.

This problem cannot be overcome by first printing the other layers such as ink layers onto the substrate, and only then applying the oxygen barrier coating layer. It has been found that a manufacturing process with said sequence of steps results in a product that does not have satisfactory oxygen barrier properties, as determined by the oxygen transmission rate (OTR) of said product.

It was therefore the problem of the present invention to provide a product such as a flexible packaging for food applications that overcomes the above drawbacks of the prior art.

According to the present invention, the above problem has been solved by the subject-matter defined in the claims.

In one embodiment, the present invention is related to a kit, comprising
a) a composition for preparing an oxygen barrier coating comprising a polymer having reactive hydroxyl groups,
b) a composition for preparing a layer selected from the group consisting of an ink layer and an overprint varnish layer,
c) optionally a composition for preparing an adhesive layer, characterized in that at least one of compositions b and c) comprises a component that is capable of crosslinking with the polymer of composition a) when compositions a) and b) and optionally c) are applied one after another onto an uncoated or coated substrate such that at least one of compositions b) and c) that comprises said component that is capable of crosslinking with the polymer of composition a) is applied adjacent to composition a).

It has been found that when an oxygen barrier coating composition comprising a polymer having reactive hydroxyl groups, preferably a polymer selected from the group consisting of polyvinyl alcohol and esters and acetals thereof, and copolymers and terpolymers of vinylalcohol and esters and acetals thereof, is applied in combination with a composition that comprises a component that is capable of crosslinking with said polymer, a sequence of layers is obtained wherein the reactive hydroxyl groups of said polymer in said oxygen barrier coating layer are reacted with said component in said other adjacent layer, resulting in a crosslinking reaction between these adjacent layers. In consequence, the manufacturing process of the present invention can be carried out with a printing speed similar to commercial printing processes.

In addition, it was found that according to the present invention less coating weight of the oxygen barrier coating layer has to be applied in order to achieve the desired oxygen transmission rate (OTR).

The term “capable of crosslinking with the polymer of composition a) when compositions a) and b) and optionally c) are applied one after another” means that the respective components in adjacent layers may undergo a crosslinking reaction under typical conditions of application of layers onto a substrate, preferably under typical printing conditions, more preferably under typical conditions of flexographic or gravure printing. Those conditions are known in the art (e.g. Leach/Pierce (eds.), The Printing ink manual, Blueprint 5th ed. 1993, e.g. p. 33-52). In other words, the coated product comprises reaction products of the reactive groups, preferably hydroxyl groups, of the polymer of composition a) and the component capable of crosslinking with the polymer of the oxygen barrier layer disposed between the oxygen barrier layer and the layer adjacent to said oxygen-barrier coating layer.

The term “reactive hydroxyl groups” means that the respective polymer exhibits hydroxy groups that may undergo the crosslinking reaction defined above. Said term comprises free hydroxyl groups and modified hydroxyl groups (e.g. hydroxyl groups modified with a protective group) that become free hydroxyl groups under the applied crosslinking conditions. The hydroxyl groups may be primary hydroxyl groups, secondary hydroxyl groups, tertiary hydroxyl groups or any combination thereof.

A composition for preparing an oxygen barrier coating comprising a polymer having reactive hydroxyl groups, preferably a polymer selected from the group consisting of polyvinyl alcohol and esters and acetals thereof, and copolymers and terpolymers of vinylalcohol and esters and acetals thereof is known.

The polymer in said oxygen barrier coating composition may be a homopolymer. Said homopolymer may preferably be selected from the group consisting of polyvinyl alcohol (PVOH), polyvinyl acetate (PVA), and polyvinyl butyral (PVB).

The polymer in said oxygen barrier coating composition may be a copolymer. Said copolymer may preferably be selected from the group consisting of ethylene-vinyl alcohol copolymer (EVOH), butenediol-vinyl alcohol copolymer (BVOH), vinyl acetate-vinyl alcohol copolymer, acrylate-vinyl alcohol copolymer, and acrylate-vinyl acetate copolymer. In the case of vinyl alcohol-containing copolymers, also esters and acetals thereof may be used. Preferably, the weight average molecular weight of the polymer and/or copolymer to be used in said oxygen barrier coating composition is in a range of between 5000 and 50000 g/mol.

According to another preferred embodiment of the present invention, also terpolymers of the monomers vinyl alcohol, vinyl acetate, ethylene, butenediol, and acrylate may be used. In the case of vinyl alcohol-containing terpolymers, also esters and acetals thereof may be used.

According to another preferred embodiment of the present invention, also blends of the above polymers, copolymers and terpolymers optionally with additional polymers may be used. Such optional additional polymers must not exhibit a detrimental effect on the barrier properties of the final oxygen barrier coating layer. For example chlorinated polymers conventionally used in oxygen-barrier coating compositions, such as poly (vinyl chloride) (PVC) and poly (vinylidene chloride) (PVDC), may be present in composition a) of the kit of the present invention.

According to the present invention, it is necessary that the composition a) of the kit of the present invention provides a sufficient amount of free OH groups for the reaction with the component in the composition b) and optionally c) that is capable of crosslinking with said polymer. According to a preferred embodiment of the present invention, said composition a) of the kit of the present invention has a hydroxyl value of at least 5 mg KOH/g, preferably at least 10 mg KOH/g, and even more preferred at least 20 mg KOH/g. The upper limit of the hydroxyl values is not particularly limited and may be 600 mg KOH/g, preferably 400 mg KOH/g.

The hydroxyl value is a known parameter that defines the number of free hydroxy groups in a chemical compound. It is typically expressed by the amount of KOH (in mg) equivalent to the number of hydroxy groups in 1 g of the substance to be examined. It may be determined, for example, by acetylation of the free hydroxy groups of a substance with acetic anhydride. After completion of the reaction, water is added, and the remaining unreacted acetic anhydride is converted to acetic acid and measured by titration with potassium hydroxide.

The composition a) in the kit of the present invention comprises the polymer described above in an amount of preferably 5-50 wt.-%, more preferably 10-40 wt.-%, and even more preferred 12-30 wt.-%, based on the weight of the entire composition a).

The composition a) in the kit of the present invention may furthermore comprise at least one solvent, preferably a combination of solvents. The exact nature of the solvent to be used depends on the polymer and its respective water-solubility that is used in the composition a). The solvent may be water, an organic solvent or both water and an organic solvent. Any organic solvent that is conventionally used in coating compositions may be used. Examples are esters such as ethyl acetate, n-propyl acetate, isopropyl acetate, or neopentyl acetate, ketones such as ace-tone, or alcohols such as ethanol, n-propanol or isopropanol.

The composition a) in the kit of the present invention may comprise at least one solvent described above in an amount of preferably 44 to 95 wt.-%, more preferably 55 to 85 wt.-%, and even more preferably 65 to 83 wt.-%, based on the weight of the entire composition a).

The composition a) in the kit of the present invention may optionally comprise at least one additive that is conventionally used in oxygen barrier coating compositions. Examples are biocides, fungicides, adhesion promoters and crosslinkers such as polyethyleneimine, surfactants, and wetting aids that do not adversely affect the oxygen barrier properties of the oxygen barrier coating layer manufactured from composition a). The composition a) in the kit of the present invention comprises at least one additive described above, if present at all, in an amount of preferably 0.1 to 5 wt.-%, more preferably 0.2 to 3 wt.-%, and even more preferably 0.5 to 2 wt.-%, based on the weight of the entire composition a).

The kit of the present invention furthermore comprises a composition b). Said composition b) is used for manufacturing a layer selected from the group consisting of an ink layer and an over-print varnish layer. Such compositions are known in the art and will be explained below. The compositions b) of the kit of the present invention preferably differ, however, from known compositions by the additional presence of a component that is capable of crosslinking with the polymer of composition a) when compositions a) and b) are applied one after another onto an un-coated or coated substrate. It is to be understood, however, that in embodiments where an optional composition c) is also used that comprises said component that is capable of crosslinking with the polymer of composition a), and wherein said compositions a) and c) are applied one after another onto an uncoated or coated substrate, said composition b) does not necessarily have to comprise said component that is capable of crosslinking with the polymer of composition a).

Compositions for making ink layers are generally known. While the composition can be applied on a substrate by any standard technique, according to the present invention it is preferred to use ink compositions that are adapted for application by flexo-graphic or gravure printing.

Compositions for making ink layers for flexible packaging materials comprise a binder component. According to the present invention, any binder conventionally used for making ink layers for flexible packaging materials is suitable. Suitable examples are acrylic or methacrylic acid resins, polyurethane resins, rosin-based resins, polyamide resins, polyvinylchloride, polyesters such as polyester polyols, cellulose and derivatives such as nitrocellulose or cellulose acetate butyrate, lignin and derivatives such as nitro lignin, and combinations thereof.

Preferably, the composition b) of the kit of the present invention for making ink layers comprises 10 to 60 wt.-%, more preferably 20 to 40 wt.-%, based on the weight of the entire composition, of said binder component.

Compositions for making ink layers for flexible packaging materials furthermore comprise at least one solvent. According to the present invention, any solvent conventionally used for making ink layers for flexible packaging materials is suitable. Suitable examples are water or preferably an organic solvent such as methyl ethyl ketone, an alcohol such as ethanol or iso-propanol, ethyl acetate, isopropyl acetate, tetrahydrofuran, di-chloromethane, acetone, dimethyl formamide, acetonitrile, dimethyl sulfoxide, and combinations thereof.

Preferably, the composition b) of the kit of the present invention for making ink layers comprises 10 to 30 wt.-%, more preferably 15 to 25 wt.-%, based on the weight of the entire composition, of said at least one solvent.

Compositions for making ink layers for flexible packaging materials preferably comprise at least one colorant, preferably a dye or a pigment, especially preferred a pigment. According to the present invention, any colorant conventionally used for making ink layers for flexible packaging materials is suitable.

Depending on the kind of colorant used, the composition may pro-vide a colored layer or a white layer.

If a colored layer is to be provided, the colorant may be selected from the group consisting of a cyan pigment, a magenta pigment, a yellow pigment, and a black pigment.

Such pigments are generally known in the art. Examples of suitable commercially available pigments are Permanent Yellow DHG, Permanent Yellow GR, Permanent Yellow G, Permanent Yellow NCG-71, Permanent Yellow GG, Hansa Yellow RA, Hansa Brilliant Yellow 5GX-02, Hansa Yellow X, NOVAPERM YELLOW HR, NOVAPERM YELLOW FGL, Hansa Brilliant Yellow 10GX, Permanent Yellow G3R-01, HOSTAPERM YELLOW H4G, HOSTAPERM YELLOW H3G, HOSTAPERM ORANGE GR, HOSTAPERM SCARLET GO, Permanent Rubine F6B, L74-1357 Yellow, L75-1331 Yellow, L75-2337 Yellow, DALAMAR YELLOW YT-858-D, CROMOPHTHAL YELLOW 3 G, CROMOPHTHAL YELLOW GR, CROMOPHTHAL YELLOW 8 G, IRGAZINE YELLOW 5GT, IRGALITE RUBINE 4BL, MONASTRAL MAGENTA, MONASTRAL SCARLET, MONASTRAL VIOLET, MONASTRAL RED, MONASTRAL VIOLET, LUMOGEN LIGHT YELLOW, PALIOGEN ORANGE, HELIOGEN BLUE L 690 IF, HELIOGEN BLUE TBD 7010, HELIOGEN BLUE K 7090, HELIOGEN BLUE L 710 IF, HELIOGEN BLUE L 6470, HELIOGEN GREEN K 8683, HELIOGEN GREEN L 9140, QUINDO MAGENTA, INDOFAST BRILLIANT SCARLET, QUINDO RED 6700, QUINDO RED 6713, INDOFAST VIOLET, Maroon B STERLING NS BLACK, STERLING NSX 76, and MOGUL L.

According to a preferred embodiment of the present invention, the ink layer to be manufactured from composition b) of the kit of the present invention is a white ink layer. In this embodiment, composition b) comprises as a colorant a white pigment. Suitable white pigments are generally known in the art. Examples are TiO₂, calcium carbonate, zinc oxide, alumina-TiO₂, barium sulphate and mixtures thereof.

Preferably, the composition b) of the kit of the present invention for making ink layers comprises 0 to 70 wt.-%, more preferably 20 to 60 wt.-%, based on the weight of the entire composition, of said colorant, preferably pigment, most preferably white pigment.

Compositions for making ink layers for flexible packaging materials may optionally comprise at least one additive. According to the present invention, any additive conventionally used for making ink layers for flexible packaging materials is suitable. Typically used additives may be selected from the group consisting of a wax, surfactants, biocides, adhesion promoters and crosslinkers such as polyethyleneimine, fillers, materials for pH adjustment, sequestering agents, preservatives, antioxidants (e.g. Irganox 1010), plasticizers, compatibility additives, emulsifiers, and adhesion promoters (such as Vertec PI-2 from Johnson Mathey; this is a titanate coupling agent (Ethoxy iso-propoxy titanium bis (2, 4-pentanedionate)). Such additives are known.

Typical fillers are calcium carbonate, magnesium carbonate, china clay, or mixtures thereof.

Typical waxes are polyethylene or paraffin waxes.

Preferably, the composition b) of the kit of the present invention for making ink layers comprises 0 to 20 wt.-%, more preferably 0.1 to 10 wt.-%, based on the weight of the entire composition, of at least one additive.

Compositions for making overprint varnish (OVP) layers are also generally known. While the composition can be applied on a substrate by any standard technique, according to the present invention it is preferred to use overprint varnish (OVP) compositions that are adapted for application by flexographic or gravure printing.

Overprint varnish (OVP) compositions generally differ from ink compositions by the absence of a colorant such as a pigment. Thus, the above description for compositions b) for making ink layers also applies with respect to the binder component, at least one solvent, and the optional additives. However, the composition b) of the kit of the present invention for making over-print varnish (OVP) layers preferably comprises 20 to 80 wt.-%, more preferably 30 to 75 wt.-%, based on the weight of the entire composition, of said binder component.

The kit according to the present invention may comprise an optional composition c) for preparing an adhesive layer. Adhesive layers are known in the art. For the purposes of the present invention, any adhesive layer conventionally used to bond films in flexible laminates may be employed. One adhesive type used to bond separate films into flexible composite laminates is polyurethane, which may be solvent-based, solvent-free or water-based. Solvent based and solvent free polyurethane adhesives are preferred. Polyurethane adhesives are based on reaction of an isocyanate moiety containing component with an isocyanate re-active component. In one component (1K) variations the isocyanate moiety containing component is reacted with the isocyanate reactive component to form an isocyanate moiety containing, moisture reactive, oligomer or prepolymer. The prepolymer is disposed between substrates to be bonded and exposed to moisture from the atmosphere and substrate surfaces to initiate cross-linking and bonding of the substrates. The prepolymer must be prepared and stored under moisture free conditions until use. In two component (2K) variations the isocyanate moiety containing component and the isocyanate reactive component are stored separately and only mixed shortly before use. Mixing the two components initiates a crosslinking reaction with the reaction products typically being an insoluble, thermoset solid. The mixed adhesive is disposed between substrates to be bonded wherein the crosslinked adhesive bonds the substrates. The iso-cyanate moiety containing component can be a polyisocyanate, an isocyanate containing oligomer or prepolymer or a combination thereof. Polyisocyanates useful by themselves or as a reactant with a polyol for preparing an isocyanate functional oligomer or prepolymer are described herein. MDI and/or its isomers is one useful polyisocyanate. The isocyanate reactive component typically comprises one or more polyols. Polyols that can be used include those polyols typically used for the production of poly-urethanes, including, without limitation, polyether polyols, polyester polyols, polybutadiene polyols, polycarbonate polyols, polyacetal polyols, polyamide polyols, polyesteramide polyols, polyalkylene polyether polyols, polythioether polyols and mixtures thereof; preferably polyether polyols, polyester polyols, polycarbonate polyols and mixtures thereof; and more preferably polyester polyols, polyether polyols and combinations thereof.

Examples of a solvent free and water free 2K polyurethane adhesive include LOCTITE LIOFOL LA7732/LA6159, LA7780/LA6159 and LA1139-04/LA6029 (all commercially available from Henkel).

As stated above, the composition b) of the kit of the present invention differs from conventional ink compositions and over-print varnish (OVP) compositions in that composition b) comprises a component that is capable of crosslinking with the polymer of composition a) when compositions a) and b) are applied one after another onto an uncoated or coated substrate such that composition b) is applied in contact with composition a).

Said component that is capable of crosslinking with the polymer of composition a) may be contained in or added directly to composition b) described above. However, according to the present invention it is preferred to provide a two-component (2k) system comprising composition b) and said component that is capable of crosslinking with the polymer of composition a) separately. A similar 2K system may also be used with respect to the optional composition c) and said component that is capable of crosslinking with the polymer of composition a).

According to the present invention, any component that is capable of crosslinking with the polymer of composition a) may be used, i.e. any component that is capable of reacting with free functional groups of the polymer of composition a). The free functional groups of the polymer of composition a) are most preferably hydroxyl groups.

According to a preferred embodiment of the present invention, the said component that is capable of crosslinking with the polymer of composition a) thus comprises functional groups that are capable of reacting with hydroxyl groups. Preferably, said component that is capable of crosslinking with the polymer of composition a) thus comprises at least one functional group that is selected from the group consisting of isocyanate, isocyanurate, carbodiimide, aziridine, epoxide, styrene maleic anhydride, silane and polyethylene imine, or combinations thereof. According to the present invention, said component that is capable of crosslinking with the polymer of composition a) preferably comprises isocyanate groups.

According to a preferred embodiment of the present invention, the isocyanate is a polyisocyanate. The polyisocyanate may, for example, be an aromatic polyisocyanate such as naphthalene 1,5-diisocyanate, polyphenylene polymethylene polyisocyanate, 4,4′-diphenylmethane diisocyanate including its isomers (hereinafter referred to as MDI), 2, 4-tolylene diisocyanate (hereinafter referred to as 2, 4-TDI) or 2, 6-tolylene diisocyanate (hereinafter referred to as 2, 6-TDI); an aralkyl polyisocyanate such as xylylene diisocyanate or tetramethylxylylene diisocyanate; an ali-phatic polyisocyanate such as hexamethylene diisocyanate (hereinafter referred to as HDI); an alicyclic polyisocyanate such as isophorone diisocyanate (hereinafter referred to as IPDI) or 4, 4′-methylenebis (cyclohexyl isocyanate); an isocyanate functional oligomer or prepolymer; or a modified product such as an urethane modified product, an allophanate modified product, a carbodiimide modified product or an isocyanurate modified product, obtainable from such a polyisocyanate. Particularly preferred is a polyisocyanate having two isocyanate groups, such as hexamethylene diisocyanate, isophorone diisocyanate, 2,4-tolylene diisocyanate or 2, 6-tolylene diisocyanate.

Examples of suitable epoxy-containing components include glycidyl acrylate, glycidyl methacrylate, and combinations thereof.

According to the present invention, said component that is capable of crosslinking with the polymer of composition a) may be a monomer, dimer, trimer, an oligomer, pre-polymer or a polymer.

According to the present invention, the term “oligomer” refers to a molecule that consists of a few repeating units which are derived from monomers. An oligomer differs from a polymer with respect to the number of repeating units, said number being smaller in oligomers. There is no sharp distinction between oligomers and polymers. Typically, a molecule comprising 5-100 repeating units is referred to an oligomer, whereas a molecule having more than 100 repeating units is referred to as “polymer”.

According to the present invention, the term “pre-polymer” refers to a monomer or system of monomers that have been reacted to an intermediate molecular mass state. This material is capable of further polymerization by reactive groups to a fully cured high molecular weight state. A difference between an oligomer and a pre-polymer is that a pre-polymer is an intermediate product of a reaction leading to a polymer.

According to the present invention, said component that is capable of crosslinking with the polymer of composition a) is present in composition b) in a ratio of 1-40 wt.-%, preferably 5-30 wt.-%, based on the total weight of the composition. Said component that is capable of crosslinking with the polymer of composition a) is present in optional composition c) in a ratio of 50-100 wt.-% for one component polyurethane adhesives and 40-70 wt.-% for two component polyurethane adhesives, in each case based on the total weight of the composition c). In certain embodiments that the optional composition c) is at least one polyurethane, the mixing ratio by weight of the isocyanate moiety containing component and the isocyanate reactive component is no less than 0,8:1, preferably no less than 1, 0:1, more preferably no less than 1,2:1, and in particular no less than 1, 5:1.

In the preferred embodiment of the present invention wherein there is provided a two-component (2k) system comprising composition b) and said component that is capable of crosslinking with the polymer of composition a) separately, said component that is capable of crosslinking with the polymer of composition a) is provided as a separate composition comprising said component that is capable of crosslinking with the polymer of composition a) and a solvent. A similar 2K system may also be used with respect to the optional composition c) and said component that is capable of crosslinking with the polymer of composition a).

According to the present invention, any solvent conventionally used for making ink layers for flexible packaging materials is suitable. Suitable examples are water or preferably an organic solvent such as methyl ethyl ketone, an alcohol such as ethanol or isopropanol, ethyl acetate, isopropyl acetate, tetrahydrofuran, dichloromethane, acetone, dimethyl formamide, acetonitrile, dimethyl sulfoxide, and combinations thereof.

Preferably, the separate composition comprising said component that is capable of crosslinking with the polymer of composition a) and a solvent comprises 5 to 50 wt.-%, more preferably 15 to 40 wt.-%, based on the weight of the entire separate composition, of said at least one solvent. The remaining portion of the separate composition (i.e. 50-90 wt.-%, preferably 60-85 wt.-%) is the component that is capable of crosslinking with the polymer of composition a). Optionally, any of the additives described above may be present in the amount described above for composition b).

The kit of the present invention may be provided in any suitable form. Preferably, said kit may be in form of a container (such as a cardboard package) comprising separate compartments (such as bags, bottles, cartridges, hobbocks, drums, IBC containers, liquid totes, etc.) for composition a), composition b), optional composition c) and optionally (in the preferred embodiment where composition b) is a 2K system) for the separate composition comprising said component that is capable of crosslinking with the polymer of composition a).

According to the the preferred embodiment of the present invention where composition b) and/or optional composition c) is a 2K system, composition b) and the separate composition comprising said component that is capable of crosslinking with the polymer of composition a) are preferably added together directly before printing. It has been found that this has resulted in an improved OTR result.

The kit of the present invention may be used for providing a coated product with improved oxygen barrier properties.

Accordingly, the present invention is also related to a coated product, comprising a substrate and a sequence of layers applied on at least one surface of said substrate, said sequence of layers comprising:
an oxygen-barrier coating layer comprising a polymer having reactive hydroxyl groups, and
a layer adjacent to said oxygen-barrier coating layer,
optionally an adhesive layer adjacent to said oxygen-barrier coating layer,

characterized in that said oxygen-barrier coating layer and said layer and/or said optional adhesive layer adjacent to said oxy-gen-barrier coating layer are crosslinked due to a reaction of said polymer in said oxygen-barrier coating layer with a component in said layer adjacent to said oxygen-barrier coating layer.

In other words, the coated product comprises reaction products of the reactive groups, preferably hydroxyl groups, of the polymer and the component capable of crosslinking with the polymer of the oxygen barrier layer disposed between the oxygen barrier layer and the layer adjacent to said oxygen-barrier coating layer.

The coated product that is prepared with the kit of the present invention comprises a substrate.

According to the present invention, the substrate may be any material suitable for use in a flexible packaging material. Examples of substrates suitable according to the present invention are a film of polyethylene such as MDO-PE (machine direction oriented PE), biaxially oriented polyethylene (BOPE), biaxially oriented polypropylene (BOPP), polyethylene terephthalate (PET), oriented polyamide (OPA) or polylactic acid (PLA). It is also possible to use paper, metallized paper or cardboard as a substrate.

According to the present invention, the dimensions of the substrate are not particularly limited. Preferably, said substrate has a thickness of more than 10 μm, preferably 10-150 μm.

Onto at least one surface of said substrate, there may be applied directly a sequence of oxygen barrier coating layer and ink layer or overprint varnish layer, and optionally adhesive layer, using the kit of the present invention. In the case where an ink layer is provided, preferably a white ink layer, a sequence of substrate-ink layer-oxygen barrier layer-optional adhesive layer is preferably provided.

In the case where an overprint varnish layer is provided, a sequence of substrate-oxygen barrier layer-overprint varnish layer is preferably provided.

In the case where an optional adhesive layer is provided, a sequence of substrate-ink layer-oxygen barrier layer-adhesive layer is preferably provided.

According to a preferred embodiment of the present invention, the coated product is a composite laminate structure, comprising:
a substrate having a surface;
at least one color layer disposed on the substrate surface;
an oxygen barrier layer disposed on the substrate surface, the oxygen barrier layer comprising a polymer having reactive hydroxyl groups;
a backing layer disposed on the oxygen barrier layer, the backing layer comprising a component that is capable of crosslinking with the polymer of the oxygen barrier layer; and

reaction products of the reactive hydroxyl groups and the component capable of crosslinking with the polymer of the oxygen barrier layer disposed between the oxygen barrier layer and the backing layer.

The backing layer may be selected from the group consisting of an ink layer, an overprint varnish layer and an adhesive layer.

According to another preferred embodiment of the present invention said composite laminate structure comprises an ink layer disposed between said at least one ink layer and said oxygen barrier layer, said ink layer comprising a component that is capable of crosslinking with the reactive hydroxyl groups of the polymer; and

reaction products of the reactive hydroxyl groups and the component capable of crosslinking with the polymer of the oxygen barrier layer disposed between the oxygen barrier layer and the additional ink layer.

According to a preferred embodiment of the present invention, composition a) is applied in a dry solids coating weight in the range from 0,2 g/m² to 2 g/m², preferably 0,5 g/m² to 1,5 g/m², more preferably 0,6 g/m² to 1,2 g/m². An oxygen barrier coating layer obtained therefrom exhibits a desired OTR value as measured at 0% relative humidity of less than 50 cm³/m²/24h, preferably less than 30 cm³/m²/24h, more preferably less than 20 cm³/m²/24h, even more preferably less than 5 cm³/m²/24h, and especially preferred less than 1 cm³/m²/24h. OTR values can be measured by any method known in the art, preferably with the method described in the examples.

According to a preferred embodiment of the present invention, one or more color layers are preferably provided onto at least one surface of said substrate, and on the uppermost of said color layers the sequence of oxygen barrier coating layer and ink layer or overprint varnish layer, and optional adhesive layer, is provided.

One of said color layers may also be a white layer.

According to a preferred embodiment of the present invention, 1 to 10, preferably 4-7, additional color layers are provided onto at least one surface of said substrate, and on the uppermost of said color layers the sequence of oxygen barrier coating layer and ink layer or overprint varnish layer, and optional adhesive layer, is provided.

According to the present invention, the color layers may be made from any ink composition conventionally used for flexible packaging. Compositions for making such ink layers are generally known. While the composition can be applied on a substrate by any standard technique, according to the present invention it is preferred to use ink compositions that are adapted for application by flexographic or gravure printing. Reference can be made to the above description where composition b) of the kit of the present invention is a composition for making an ink layer, the composition without the component that is capable of crosslinking with the polymer of composition a).

In the case of this preferred embodiment where a white ink layer is provided from said kit of the present invention, the sequence of substrate-color layer(s)-white layer-oxygen barrier layer-optional adhesive layer is preferably provided.

In the case of this preferred embodiment where an overprint varnish layer is provided from said kit of the present invention, the sequence of substrate-color layer(s)-oxygen barrier layer-overprint varnish layer is preferably provided.

According to a further embodiment of the present invention, the coated product that is prepared with the kit of the present invention is a laminate. According to the present invention, the term “laminate” refers to a product that consists of a sequence of layers, wherein an outermost layer or a core layer is defined as substrate or substrate layer. A laminate may also preferably comprise more than one of those substrate layers, most preferably as outermost layers, and in between these substrate layers there may be provided a coated layer or several coated layers.

According to a preferred embodiment of the present invention, said laminate comprises the following sequence of layers: Substrate-color layer(s)-white ink layer-oxygen barrier coating layer-adhesive layer-substrate (sealant film).

In said preferred embodiment, the white ink layer may either be a conventional white ink layer as described above, or a white ink layer made from composition b) of the kit of the present invention, i.e. comprising a component that is capable of cross-linking with the polymer of composition a) of the kit of the present invention.

In said preferred embodiment, the adhesive layer may either be a conventional adhesive layer as described above, or an adhesive layer comprising a component that is capable of crosslinking with the polymer of composition a) of the kit of the present invention.

It is necessary according to the present invention that at least one of said white ink layer and said adhesive layer comprises a component that is capable of crosslinking with the polymer of composition a) of the kit of the present invention.

In said preferred embodiment, the substrate provided on top of said adhesive layer may be a substrate as described above, or preferably it may be a heat weldable or sealable film, more preferably a heat weldable or sealable film made from a polyolefin such as polyethylene.

The layers described above can be applied onto the substrate by any conventional coating technique, preferably by flexographic or gravure printing.

Gravure and flexography are the major printing processes for printing packing materials. These processes can be used for printing a large variety of substrates, such as paper, cardboard, or plastic substrates. The gravure and flexographic printing processes are well-known. Reference may be made, for example, to Leach/Pierce (Eds.), The printing ink manual, Blueprint, London, 5th ed. 1993, p, 33-53. Also the characteristics of gravure and flexographic inks are known to the skilled man. Reference may be made, for example, to Leach/Pierce (Eds.), The printing ink manual, Blueprint, London, 5th ed. 1993, p, 473-598. The respective content of those chapters is incorporated herein by reference.

The layers described above are applied, according to a preferred embodiment of the present invention, in such an amount that a coating weight of 0.2-1.5 g/m², preferably 0.4-1.3 g/m², and especially preferred 0.6-1.0 g/m² is obtained for each layer. With respect to the oxygen barrier coating layer, reference is made to the description above.

The present invention is thus also related to a method for making a coated product, comprising the steps:
a) providing a substrate having a surface;
b) providing a liquid composition a) for preparing an oxygen barrier coating layer, the liquid composition a) comprising a polymer having reactive hydroxyl groups;
c) providing a liquid composition b) for preparing a layer selected from the group consisting of an ink layer and an overprint varnish layer, and optionally providing a liquid composition c) for preparing an adhesive layer, wherein at least one of compositions b) and c) comprises a component that is capable of crosslinking with the polymer of composition a);
d) optionally applying at least one color layer onto the surface of said substrate;
e) applying, in either sequence, the liquid composition a) and the liquid composition b) onto the surface of the substrate or the at least one color layer to form a sequence of layers comprising an oxygen barrier layer and an ink layer or an overprint varnish layer adjacent to said oxygen barrier layer,
f) optionally applying the liquid composition c) onto the sequence of layers obtained in step e), so as to form an adhesive layer,
g) crosslinking the component in at least one of compositions b) and c) with the polymer in composition a).

In step d), a color or white ink layer or a sequence of color and white ink layers may be applied onto said at least one surface of said substrate.

Optionally, in a further step an additional substrate such as a heat weldable or sealable film may be applied onto the optional adhesive layer formed in step f).

As described above, the layers described above can be applied onto the substrate by any conventional coating technique, preferably by flexographic or gravure printing.

According to a preferred embodiment of the present invention, the method is conducted as an in-line printing process. An in-line printing process is a process where a layer is applied directly onto a previously applied layer in a single process and while the substrate is in continuous motion. In an in-line process, a layer is applied onto a previously applied layer which is still wet (wet-on-wet process). Alternatively, a drying step may be performed before application of the layer onto a previously applied layer, wherein said drying step is performed in-line and does not interrupt the process. In-line printing processes are generally known.

The method of the present invention may be performed in-line, using conventional equipment and conventional equipment line speeds in contrast to previous methods for providing an oxygen barrier coating.

According to the present invention, said coated product is preferably a composite laminated structure useful to form flexible packaging.

Many articles such as food articles are stored in flexible packaging, i.e. sealed packaging surrounding the food article which is made of a material which shows some flexibility and can thus undergo certain modifications of its shape.

Flexible packagings are widely used in areas like food packaging (e.g., retortable bags, frozen food packaging, refrigerated food packaging, shelf stable food packaging, dry goods packaging, liquid food packaging, fast food wrappers and bags), pharmaceutical packaging (e.g., primary packaging, secondary packaging, booklets and instructions), personal hygiene packaging (e.g. soap packaging, hair care packaging, baby care packaging, feminine care packaging, male care packaging), home care packaging (e.g. detergent packaging, cleaner packaging), agricultural packaging (e.g., herbicide packaging, pest control packaging, fertilizer bags), industrial packaging (e.g. shopping bags, construction wrappers and bags), and pet care packaging (e.g., pet food bags, pet medical packaging, pet hygiene packaging).

The present invention will be described hereafter with respect to non-limiting examples and drawings.

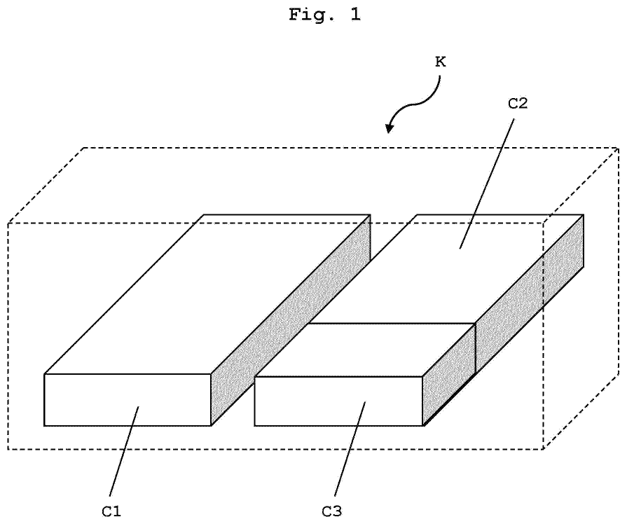

FIG. 1 shows an embodiment of a kit according to the present invention

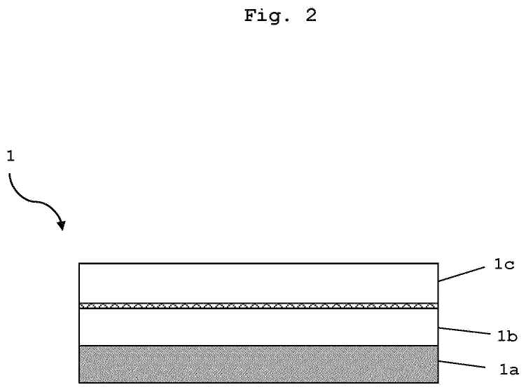

FIG. 2 shows a first embodiment of a coated product in accordance with the present invention

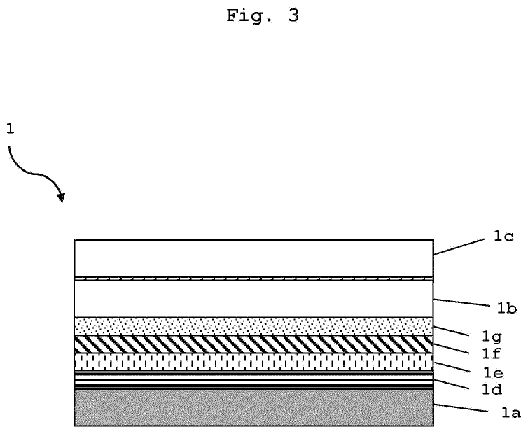

FIG. 3 shows a second embodiment of a coated product in accordance with the present invention

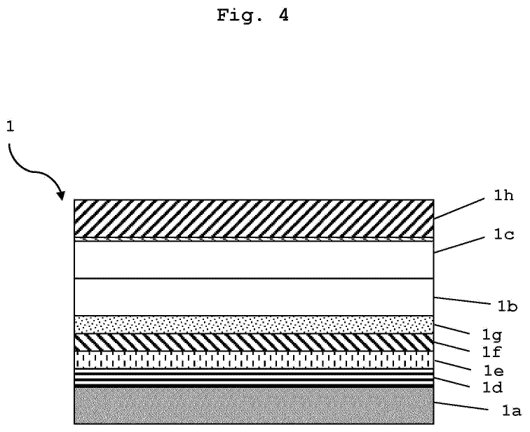

FIG. 4 shows a third embodiment of a coated product in accordance with the present invention

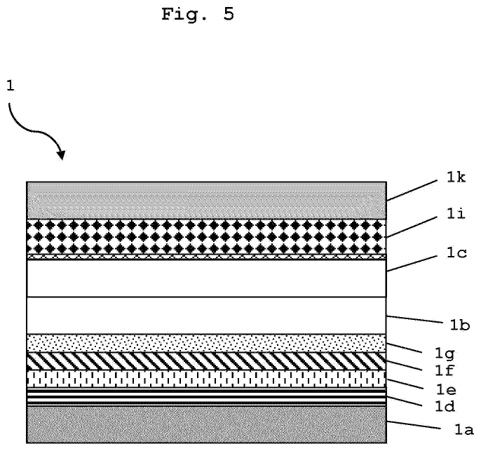

FIG. 5 shows a fourth embodiment of a coated product in accordance with the present invention

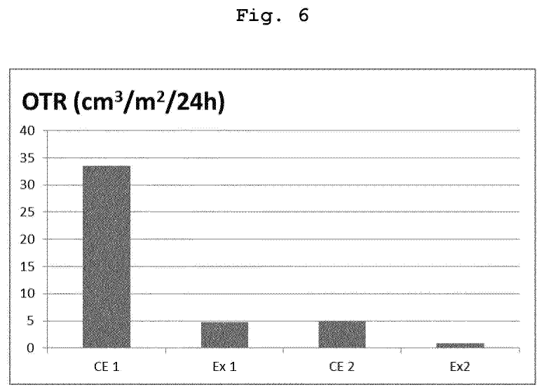

FIG. 6 shows the result of OTR measurements for a first set of examples

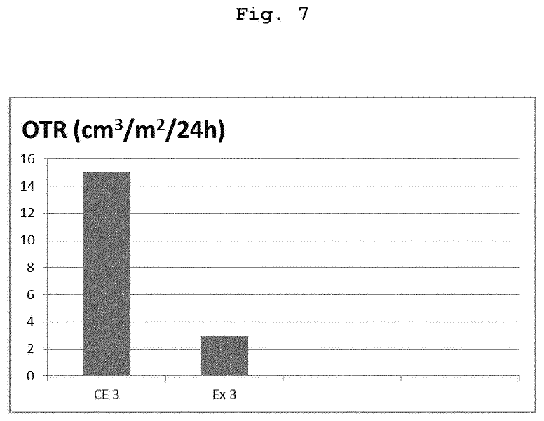

FIG. 7 shows the result of OTR measurements for a second set of examples

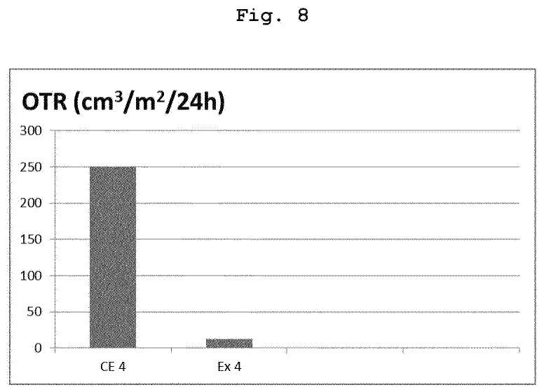

FIG. 8 shows the result of OTR measurements for a third set of examples

In the figures, same reference signs denote the same components.

FIG. 1 shows an embodiment of a kit K according to the present invention. In FIG. 1, said kit K is a package comprising two cartridges. A first cartridge comprises a compartment C1 in which the composition a) of the kit of the present invention is stored. A second cartridge comprises a compartment C2 in which the composition b) of the kit of the present invention is stored, but without the component that is capable of crosslinking with the polymer of composition a). Said component that is capable of crosslinking with the polymer of composition a) is stored in a third compartment C3. According to this embodiment, the composition b) of the kit of the present invention is a 2K composition.

FIG. 2 shows a first embodiment of a coated product 1 in accordance with the present invention. The product 1 comprises a substrate 1ₐ, such as polyolefin film. For example, a film made of BOPP (biaxially oriented polypropylene) may be used as substrate 1a.

On one surface of said substrate 1a, a sequence of layers is applied using the kit K of the present invention. In the embodiment according to FIG. 2, first a white ink layer 1b is applied using the composition b) of the kit K of the present invention. Said composition b) of the kit K of the present invention comprises a component that is capable of crosslinking with the polymer of composition a). Thereafter, an oxygen barrier coating layer 1c is applied using the composition a) of the kit K of the present invention. When layers 1b, 1c have been applied adjacent each other, a crosslinking reaction takes place, as indicated in FIG. 2 by the shaded region between layers 1b, 1c.

FIG. 3 shows a second embodiment of a coated product 1 in accordance with the present invention. The second embodiment differs from the first embodiment of FIG. 1 in the presence of color layers 1d, 1e, 1f, 1g. In FIG. 3, four exemplary purposes 4 color layers are shown. This is a non-limiting embodiment. For example, the color layers 1d, 1e, 1f, 1g may be (in arbitrary sequence) a black color layer, a cyan color layer, a magenta color layer and a yellow color layer.

In the embodiment according to FIG. 3, the layers 1d, 1e, 1f, 1g are first applied onto one surface of the substrate 1a. Thereafter, as in the embodiment of FIG. 2, sequence of layers 1b, 1c is applied using the kit K of the present invention.

FIG. 4 shows a third embodiment of a coated product 1 in accordance with the present invention. The third embodiment differs from the second embodiment of FIG. 2 in the presence of an over-print varnish layer 1h applied on one surface of the oxygen barrier coating layer 1c. In the embodiment according to FIG. 4, the layer 1b is a conventional white ink layer without a component that is capable of crosslinking with the polymer of composition a). The sequence of oxygen barrier coating layer 1c and overprint varnish layer 1h is applied using the kit K of the present invention. When layers 1c, 1h have been applied adjacent each other, a crosslinking reaction takes place, as indicated in FIG. 4 by the shaded region between layers 1c, 1h.

FIG. 5 shows a fourth embodiment of a coated product 1 in accordance with the present invention. The fourth embodiment differs from the third embodiment of FIG. 3 instead of the over-print varnish layer 1h in FIG. 3, here an adhesive layer 1i has been applied onto the oxygen barrier coating layer 1c. The sequence of oxygen barrier coating layer 1c and adhesive layer li is applied using the kit K of the present invention. When layers 1c, 1i have been applied adjacent each other, a crosslinking reaction takes place, as indicated in FIG. 5 by the shaded region between layers 1c, 1i.

Finally, onto one surface of the adhesive layer 1i a further substrate 1k is applied. In FIG. 5, substrate 1k is a heat weldable or sealable film, for example a polyethylene (PE) film.

### Comparative Example 1 (CE 1)

A first white ink was formulated with the components indicated in table 1.

TABLE 1

| Component | Wt.-% |
|---|---|
| PVC varnish (blend of PVC, cellulose acetate | 30.2 |
| butyrate, and polyurethane) | |
| White pigment (master grind) | 50 |
| Solvent (blend of methyl ethyl ketone and ethyl acetate) | 17 |
| Plasticizer | 1.1 |
| Wax | 0.7 |
| Antioxidant | 1 |

This ink was diluted with ethyl acetate to a printing viscosity of 28 seconds flow on a #2 GE Zahn cup. The ink was applied to 70 gauge biaxially oriented polypropylene (BOPP) film using a hand proofer (supplied by Early Manufacturing, Brevard, NC, USA; equipped with a 360 lpi (142 lines per cm), 5.0 bcm (3.23 cm³) anilox roller). The resulting prints were manually dried using an electric hair dryer.

An oxygen-barrier coating composition was formulated with the components indicated in table 2.

TABLE 2

| Component | Wt.-% |
|---|---|
| butenediol vinylalcohol copolymer | 15 |
| Water | 57.4 |
| Solvent (ethanol or aliphatic acetone) | 27 |
| Surfactant | 0.4 |
| Adhesion promoter | 0.2 |

Said oxygen barrier coating was applied directly upon the surface of the dried white ink using a K-Coater fitted with a #3 wire-wound coating rod (RD Specialties) to yield a dry solids coating weight of 0.5 g/m². After manual drying using a hair dryer, the resulting print was placed in a laboratory oven at 50° C. for one hour to facilitate complete drying of the printed samples.

### Example 1

Comparative example 1 was repeated, but the white ink composition of table 1 was blended before printing with the composition according to table 3.

TABLE 3

| Component | Wt.-% |
|---|---|
| Isocyanate functional pre-polymer based on TDI | 65 |
| (toluene diisocyanate) | |
| Solvent (ethyl acetate) | 35 |

The compositions according to tables 1 and 3 were blended in a ratio of 70:30 (i.e. 70 wt. % of the white ink composition of table 1 and 30 wt.-% of the crosslinking composition of table 3).

This blend was used instead of the white ink composition of table 1 alone. After the oxygen barrier coating was applied and dried manually, the resulting print was placed in a laboratory oven at 50° C. for 16 hours.

### Comparative Example 2 (CE 2)

Comparative example 1 was repeated, but the white ink composition of table 1 was replaced by the white ink composition according to table 4.

TABLE 4

| Component | Wt.-% |
|---|---|
| Acrylic varnish | 50.76 |
| White pigment | 30 |
| Solvent (ethyl acetate) | 18.26 |
| Adhesion promoter | 0.98 |

### Example 2

Example 1 was repeated, but the white ink composition of table 1 was replaced by the white ink composition according to table 4. The compositions according to tables 4 and 3 were blended in a ratio of 90:10.

### OTR Tests for Examples 1 and 2 and Comparative Examples 1 and 2

The print samples obtained in examples 1 and 2 and comparative examples 1 and 2 were subjected to oxygen transmission rate (OTR) measurements using an Ox-Tran 2/22 OTR Analyzer (Ametek Mocon, Brooklyn Park, MN, USA). Print samples were mounted to the sample cells such that the BOPP film was oriented toward the test gas (100% Oxygen). The full test parameters are specified below:

Ox-Tran 2/22 Experimental Parameters

| Sample Cell Area | 5.62 | cm² |
|---|---|---|
| Carrier Gas | 2% Hydrogen in Nitrogen | |
| Carrier Gas Relative Humidity | 0% | |
| Test Gas | 100% Oxygen | |
| Test Gas Relative Humidity | 0% | |
| Cell Temperature | 23° | C. |
| Test Mode | Convergence by cycle, 3 | |
| | cycles, 1% convergence | |
| Cycle Time | 30 | minutes |

The following results were obtained:

TABLE 5

| Example | OTR value (cm³/m²/24 h) |
|---|---|
| Comparative example 1 | 33.5 |
| Example 1 | 4.7 |
| Comparative example 2 | 5.0 |
| Example 2 | 0.9 |

The results are also shown in FIG. 6. It can be seen that for both used white ink compositions a significant improvement of the OTR value of the oxygen barrier coating applied adjacent to the respective white ink layer was obtained when a component that is capable of crosslinking with the polymer of the oxygen barrier coating composition with reactive hydroxyl groups was added.

### Example 3 and Comparative Example 3

In a commercial rotogravure printing press, conventional black, cyan, magenta and yellow inks were printed in said sequence onto the BOPP substrate of comparative example 1, followed by application of the oxygen barrier coating composition of table 2 with a coating weight of 1 g/m². The line speed of the rotogravure printing press was 135 m/min, and the drying temperatures in a double drier unit at the end of the printing line were 70° C./100° C.

Samples of the same printed material were further modified by applying a PVC-based overprint varnish according to table 6 directly onto the oxygen barrier coating layer.

TABLE 6

| Component | Wt.-% |
|---|---|
| Varnish (blend of polyurethane, PVC, polyesterpolyol | 76.7 |
| and cellulose acetate butyrate) | |
| Solvent (ethyl acetate) | 20 |
| Drying agent | 0.3 |
| Anti-tack agent | 0.1 |
| Wax | 2.8 |
| Plasticizer | 0.1 |

For example 3, the overprint varnish composition of table 6 was blended with the crosslinking composition of table 3 before application onto the oxygen barrier coating layer. The compositions according to tables 6 and 3 were blended in a ratio of 85:25.

For comparative example 3, the overprint varnish composition of table 6 was applied as such.

OTR measurements were made as described above. The following results were obtained (also shown in FIG. 7):

TABLE 7

| Example | OTR value (cm³/m²/24 h) |
|---|---|
| Comparative example 3 | 15 |
| Example 3 | 3 |

It can be seen that a significant improvement of the OTR value of the oxygen barrier coating applied adjacent to the respective white ink layer was obtained when a component that is capable of crosslinking with the polymer of the oxygen barrier coating composition with reactive hydroxyl groups was added to the over-print varnish composition.

### Example 4 and Comparative Example 4

In a commercial rotogravure printing press, conventional black, cyan, magenta and yellow inks as well as a conventional white ink were printed in said sequence onto the BOPP substrate of comparative example 1, followed by application of the oxygen barrier coating composition of table 2 with a coating weight of 0,8 g/m². The line speed of the rotogravure printing press was 180 m/min, and the drying temperatures in a double drier unit at the end of the printing line were 70° C./100° C.

In example 4, the obtained sample was hand laminated following typical laboratory methods. An adhesive layer (LOCTITE LIOFOL LA 1139-04/LA1139-81B solvent free adhesive from Henkel) containing a component that is capable of crosslinking with the polymer of the oxygen barrier composition was applied to the barrier coating on the print samples, using a K-Coater and RDS coating rod. The coating weight of adhesive applied was ˜1.2 g/m². A clear polyethylene heat weldable or sealable film was then placed onto the adhesive, and the laminated constructs cured at 25° C. for seven days prior to OTR measurements.

In comparative example 4, no lamination was carried out.

OTR measurements were made as described above. The following results were obtained (also shown in FIG. 8):

TABLE 8

| Example | OTR value (cm³/m²/24 h) |
|---|---|
| Comparative example 4 | 250 |
| Example 4 | 12 |

It can be seen that a significant improvement of the OTR value of the oxygen barrier coating applied was obtained when lamination with an adhesive layer composition comprising a component that is capable of crosslinking with the polymer of the oxygen barrier coating composition with reactive hydroxyl groups was carried out.

### Examples 5a, 5b and Comparative Example 5

In a commercial rotogravure printing press conventional black, cyan, magenta and yellow inks as well as a white ink according to comparative example 1 was printed onto a BOPP substrate of comparative example 1, followed by application of the oxygen barrier coating composition of table 2 with a coating weight of 0,8 g/m². The line speed of the rotogravure printing press was 180 m/min, and the drying temperatures in a double drier unit at the end of the printing line were 70° C./100° C.

In example 5a, the obtained sample was hand laminated following typical laboratory methods. An adhesive layer (LOCTITE LIOFOL LA1139-04/LA6029 solvent free adhesive from Henkel mixed in a 1:1 ratio by weight) containing a component that is capable of crosslinking with the polymer of the oxygen barrier composition was applied to the barrier coating on the print samples, using a K-Coater and RDS coating rod. The coating weight of adhesive applied was ˜1.8 g/m². A clear polyethylene sealable film was then placed onto the adhesive, and the laminated construct was cured at 25° C. for seven days prior to OTR measurements.

In example 5b, the obtained sample was hand laminated following typical laboratory methods. An adhesive layer (LOCTITE LIOFOL LA1139-04/LA6029 solvent free adhesive from Henkel mixed in a 1.5:1 ratio by weight) containing a component that is capable of crosslinking with the polymer of the oxygen barrier composition was applied to the barrier coating on the print samples, using a K-Coater and RDS coating rod. The coating weight of adhesive applied was ˜1.8 g/m². A clear polyethylene sealable film was then placed onto the adhesive, and the laminated constructs cured at 25° C. for seven days prior to OTR measurements.

In comparative example 5, no adhesive lamination was carried out.

OTR measurements were made as described above. The following results were obtained.

TABLE 9

| Example | OTR value (cm³/m²/24 h) |
|---|---|
| Comparative Example 5 | 144 |
| Example 5a (1:1 mix ratio) | 51 |
| Example 5b (1.5:1 mix ratio) | 29 |

Commercially, the LA1139-04/LA6029 adhesive is used at a mixed ratio of 1:1 by weight to provide the resulting laminate structure with more than suitable adhesion strength to the sealable film. As shown in Example 5a the adhesive at a 1:1 mix ratio not only provides adhesion but also provides a significant improvement of the laminate OTR value. A mix ratio to 1.5 LA1139-04 to 1 LA6029 is not typically used for commercial lamination of flexible packaging laminates as it introduces undesirable cost and complexity into the process and resulting product. Surprisingly, changing the mix ratio to 1.5 LOCTITE LIOFOL LA1139-04 to 1 LOCTITE LIOFOL LA6029 as done in example 5b improved OTR value of the resulting laminate even further.

### Examples 6a, 6b and 6c

In a commercial rotogravure printing press conventional black, cyan, magenta and yellow inks as well as a white ink according to example 1 was printed onto a BOPP substrate of comparative example 1, followed by application of the oxygen barrier coating composition of table 2 with a coating weight of 0,8 g/m². The line speed of the rotogravure printing press was 180 m/min, and the drying temperatures in a double drier unit at the end of the printing line were 70° C./100° C.

In example 6a, the obtained sample was hand laminated following typical laboratory methods. An adhesive layer (LOCTITE LIOFOL LA1139-04/LA6029 solvent free adhesive from Henkel mixed in a typical commercially used 1:1 ratio by weight) containing a component that is capable of crosslinking with the polymer of the oxygen barrier composition was applied to the barrier coating on the print samples, using a K-Coater and RDS coating rod. The coating weight of adhesive applied was ˜1.8 g/m². A clear polyethylene sealable film was then placed onto the adhesive, and the laminated construct was cured at 25° C. for seven days prior to OTR measurements.

In example 6b, the obtained sample was hand laminated following typical laboratory methods. An adhesive layer (LOCTITE LIOFOL LA1139-04/LA6029 solvent free adhesive from Henkel mixed in a 1.5:1 ratio by weight) containing a component that is capable of crosslinking with the polymer of the oxygen barrier composition was applied to the barrier coating on the print samples, using a K-Coater and RDS coating rod. The coating weight of adhesive applied was ˜1.8 g/m². A clear polyethylene sealable film was then placed onto the adhesive, and the laminated constructs cured at 25° C. for seven days prior to OTR measurements.

In example 6c, no adhesive lamination was carried out.

OTR measurements were made as described above. The following results were obtained.

TABLE 10

| Example | OTR value (cm³/m²/24 h) |
|---|---|
| Example 6c | 46 |
| Example 6a (1:1 mix ratio) | 19 |
| Example 6b (1.5:1 mix ratio) | 7 |

As shown in Example 6a the combination of white ink including a component that is capable of crosslinking with the polymer of the oxygen barrier coating composition and adhesive at a 1:1 mix ratio provides a substantial improvement of the laminate OTR value. Surprisingly, changing the mix ratio to 1.5 LOCTITE LIOFOL LA1139-04 to 1 LOCTITE LIOFOL LA6029 improved OTR value of the resulting laminate even further.

1-15. (canceled)

16. A kit, comprising
a) a composition for preparing an oxygen barrier coating comprising a polymer having reactive hydroxyl groups,
b) a composition for preparing a layer selected from the group consisting of an ink layer and an overprint varnish layer,
wherein
composition b) comprises a component that is capable of crosslinking with the polymer of composition a) when compositions a) and b) are applied one after another onto an uncoated or coated substrate such that composition b) that comprises said component that is capable of crosslinking with the polymer of composition a) is applied adjacent to composition a).

17. A kit, comprising
a) a composition for preparing an oxygen barrier coating comprising a polymer having reactive hydroxyl groups,
b) a composition for preparing a layer selected from the group consisting of an ink layer and an overprint varnish layer,
c) a composition c) for preparing an adhesive layer,
wherein at least one of compositions b) and c) comprises a component that is capable of crosslinking with the polymer of composition a) when compositions a) and b) and c) are applied one after another onto an uncoated or coated substrate such that at least one of compositions b) and c) that comprises said component that is capable of crosslinking with the polymer of composition a) is applied adjacent to composition a).

18. The kit according to claim 16, wherein said polymer in the composition a) is selected from the group consisting of
homopolymers selected from the group consisting of polyvinyl alcohol (PVOH), polyvinyl acetate (PVA), and polyvinyl butyral (PVB),
copolymers selected from the group consisting of ethylene-vinyl alcohol copolymer (EVOH), butenediol-vinyl alcohol copolymer (BVOH), vinyl acetate-vinyl alcohol copolymer, acrylate-vinyl alcohol copolymer, and acrylate-vinyl acetate copolymer, and esters and acetals of vinyl alcohol-containing copolymers, and
terpolymers of the monomers vinyl alcohol, vinyl acetate, ethylene, butenediol, and acrylate, and esters and acetals of vinyl alcohol-containing terpolymers,
or blends of such homopolymers, copolymers or terpolymers with an additional polymer.

19. The kit according to claim 16, wherein said component that is capable of crosslinking with the polymer of composition a) comprises at least one functional group that is selected from the group consisting of isocyanate, isocyanurate, carbodiimide, aziridine, epoxide, styrene maleic anhydride, silane and polyethylene imine.

20. The kit according to claim 16, wherein said composition b) is a 2K composition.

21. The kit according to claim 17, wherein said composition b) or said component c), or compositions b) and c), is a 2K composition.

22. The kit according to claim 16, wherein said composition b) is a composition for preparing a white ink layer.

23. A coated product, comprising a substrate and a sequence of layers applied on at least one surface of said substrate, said sequence of layers comprising:
an oxygen-barrier coating layer comprising a polymer having reactive hydroxyl groups, and
a layer adjacent to said oxygen-barrier coating layer,
wherein said oxygen-barrier coating layer and said layer adjacent to said oxygen-barrier coating layer are crosslinked due to a reaction of said polymer in said oxygen-barrier coating layer with a component in said layer adjacent to said oxygen-barrier coating layer.

24. A coated product, comprising a substrate and a sequence of layers applied on at least one surface of said substrate, said sequence of layers comprising:
an oxygen-barrier coating layer comprising a polymer having reactive hydroxyl groups,
a layer adjacent to said oxygen-barrier coating layer,
and an adhesive layer (1i) adjacent to said oxygen-barrier coating layer (1c),
wherein said oxygen-barrier coating layer and said layer or said adhesive layer, or said layer and said adhesive layer, adjacent to said oxygen-barrier coating layer are crosslinked due to a reaction of said polymer in said oxygen-barrier coating layer with a component in said layer or said adhesive layer, or said layer and said adhesive layer, adjacent to said oxygen-barrier coating layer.

25. The product according to claim 23, wherein said layer adjacent to said oxygen-barrier coating layer is an ink layer

26. The product according to claim 25, wherein said ink layer is provided on one color layer or a sequence of color layers applied onto said at least one surface of said substrate, and the oxygen-barrier coating layer is provided on said ink layer.

27. The product according to claim 23, wherein said layer adjacent to said oxygen-barrier coating layer is an overprint varnish layer.

28. The product according to claim 27, wherein said oxygen-barrier coating layer is provided on one color layer or white ink layer or a sequence of color and white ink layers applied onto said at least one surface of said substrate, and the overprint varnish layer is provided on said oxygen-barrier coating layer.

29. The product according to claim 23, wherein said layer adjacent to said oxygen-barrier coating layer is an adhesive layer.

30. The product according to claim 24, wherein said oxygen-barrier coating layer is provided on one or color or white ink layer or a sequence of color and white ink layers applied onto said at least one surface of said substrate, and on said oxygen-barrier coating layer there is provided said adhesive layer.

31. The product according to claim 30, wherein a further substrate is provided onto a free surface of said adhesive layer.

32. The product according to claim 23, wherein said product is a flexible packaging.

33. A method for making a coated product, comprising the steps:
a) providing a substrate having a surface;
b) providing a liquid composition a) for preparing an oxygen barrier coating layer, the liquid composition a) comprising a polymer having reactive hydroxyl groups;
c) providing a liquid composition b) for preparing a layer selected from the group consisting of an ink layer and an overprint varnish layer, which comprises a component that is capable of crosslinking with the polymer of composition a);
d) applying, in either sequence, the liquid composition a) and the liquid composition b) onto the surface of the substrate to form a sequence of layers comprising an oxygen barrier layer and an ink layer or an overprint varnish layer adjacent to said oxygen barrier layer,
e) crosslinking the component in composition b) with the polymer in composition a).

34. A method for making a coated product, comprising the steps:
a) providing a substrate having a surface;
b) providing a liquid composition a) for preparing an oxygen barrier coating layer, the liquid composition a) comprising a polymer having reactive hydroxyl groups;
c) providing a liquid composition c) for preparing an adhesive layer (1i), wherein at least one of compositions b) and c) comprises a component that is capable of crosslinking with the polymer of composition a);
d) applying, in either sequence, the liquid composition a) and the liquid composition b) onto the surface of the substrate to form a sequence of layers comprising an oxygen barrier layer and an ink layer or an overprint varnish layer adjacent to said oxygen barrier layer;
e) applying the liquid composition c) onto the sequence of layers obtained in step e), so as to form an adhesive layer;
f) crosslinking the component in at least one of the compositions b) and c) with the polymer in composition a).

35. The method according to claim 33, further comprising the step of applying at least one color layer onto the surface of said substrate, and applying, in either sequence, the liquid composition a) and the liquid composition b) onto the surface of the at least one color layer to form a sequence of layers comprising an oxygen barrier layer and an ink layer or an overprint varnish layer adjacent to said oxygen barrier layer.

36. The method according to claim 33, wherein the steps of applying and crosslinking are performed using an in-line process.
